(19) United States
(12) Patent Application Publication
(10) Pub. No.: US 2021/0111990 A1
(43) Pub. Date: Apr. 15, 2021

(54) SYSTEMS AND METHODS FOR PROVIDING MULTIPLE DISJOINTED PATHS TO CORE NETWORK AT FIRST-MILE ACCESS

(71) Applicant: Cisco Technology, Inc., San Jose, CA (US)

(72) Inventors: Nagendra Kumar Nainar, Morrisville, NC (US); Carlos M. Pignataro, Cary, NC (US)

(21) Appl. No.: 16/601,214

(22) Filed: Oct. 14, 2019

(51) Int. Cl. H04L 12/707; H04L 12/703; H04L 12/801

(52) U.S. Cl. CPC H04L 45/22; H04L 47/14; H04L 47/17; H04L 45/28

(57) ABSTRACT

The present disclosure addresses single point of failure at first mile network connectivity for endpoint devices. A system includes two or more first hop nodes each providing a downstream endpoint device connectivity to a core network via a corresponding second hop node. Each first hop node is configured to determine an identifier of the corresponding second hop node; and send a message to the endpoint device to create multiple disjointed paths to the core network for the endpoint device, each message including a network identifier associated with the first hop nodes and the identifier of the corresponding second hop node, the endpoint device being configured to select at least one first hop node and the corresponding second hop node to establish a path to the core network.

### TECHNICAL FIELD

The subject matter of this disclosure relates in general to the field of computer networking, and more particularly, to systems and methods for addressing single point of failure/load balancing at first mile connectivity for endpoint devices joining a network by providing the endpoint devices with multi-path awareness from the first mile point of connection toward the core network.

### BACKGROUND

An endpoint device such as a mobile device, an IoT device, etc., typically connects to a network by first connecting to an access point(AP)/e-NodeB/base station, etc., which may be referred to as the first mile connection. Single point of failure occurs when such AP (and/or a Wireless Local Area Network (LAN) Controller (WLC) acting a gateway for the AP and other nearby APs to the core network), eNodeB, etc. fails, thus cutting off the endpoint from the core network. The time it takes for the endpoint device to find an alternative AP and/or for a remote WLC or eNodeB to take over, may be relatively long. Alternatively, relying on a single path to core network for an end device may result in sub-optimal load balancing, which also introduces delays. With development of 5G networks and the required criteria for deterministic service delivery, such relatively long period of time after occurrence of a single point of failure and sub-optimal load balancing at the first mile connection is unacceptable.

### BRIEF DESCRIPTION OF THE FIGURES

To provide a more complete understanding of the present disclosure and features and advantages thereof, reference is made to the following description, taken in conjunction with the accompanying drawings, in which:

FIG. 1 illustrates an example of a physical topology of an enterprise network in accordance with one aspect of the present disclosure;

FIG. 2 illustrates a simplified configuration of first mile connectivity within the network of FIG. 1 in accordance with one aspect of the present disclosure;

FIG. 3 illustrates an example method of providing endpoint devices with multiple disjoint paths to core network in accordance with one aspect of the present disclosure;

FIG. 4 is an example of first mile connectivity within a cellular network in accordance with one aspect of the present disclosure;

FIG. 5 illustrates a process for providing multiple disjointed paths to multiple core networks in FIG. 4 in accordance with one aspect of the present disclosure;

FIG. 6 is an example of first mile connectivity within a cellular network in accordance with one aspect of the present disclosure;

FIG. 7 illustrates a process for providing multiple disjointed paths to multiple core networks in FIG. 6 in accordance with one aspect of the present disclosure; and

FIGS. 8A and 8B illustrate examples of systems in accordance with one aspect of the present disclosure.

### DESCRIPTION OF EXAMPLE EMBODIMENTS

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

As noted above, single point of failure occurs when an access point (AP) (and/or a Wireless Local Area Network (LAN) Controller (WLC) acting a gateway for the AP and other nearby APs to the core network), eNodeB, etc., that serves as a first mile connection for an endpoint device fails, thus cutting off the endpoint from the core network. The time it takes for the endpoint device to find an alternative AP and/or for a remote WLC or eNodeB to take over, may be relatively long. Alternatively, relying on a single path to core network for an end device may result in sub-optimal load balancing, which also introduces delays. Various examples described in the present application are directed to providing the endpoint devices with awareness of multiple disjointed paths toward the core network to which they are connecting, thus providing redundancy in connectivity at the first mile connection and ensuring end to end deterministic service delivery.

In one aspect, a method includes determining, at each of a number of first hop nodes, an identifier of a corresponding second hop node, each of the first hop nodes providing a downstream endpoint device connectivity to a core network, each corresponding second hop node being a next upstream hop via which a corresponding first hop node and the endpoint device connect to the core network; and sending, by each of the first hop nodes, a message to the endpoint device to create multiple disjointed paths to the core network for the endpoint device, each message including a network identifier associated with the first hop nodes and the identifier of the corresponding second hop node, the endpoint device selecting at least one first hop node and the corresponding second hop node to establish a path to the core network, based on messages received from the first hop nodes.

In one aspect, a system includes two or more first hop nodes, each of the first hop nodes providing a downstream endpoint device connectivity to a core network and two or more second hop nodes, each corresponding second hop node being a next upstream hop via which a corresponding first hop node and the endpoint device connect to the core network. Each first hop node is configured to determine, an identifier of a corresponding second hop node; and send a message to the endpoint device to create multiple disjointed paths to the core network for the endpoint device, each message including a network identifier associated with the first hop nodes and the identifier of the corresponding second hop node, the endpoint device being configured to select at least one first hop node and the corresponding second hop node to establish a path to the core network, based on messages received from the first hop nodes.

In one aspect, one or more non-transitory computer-readable media includes computer-readable instructions, which when executed by one or more processors of a number of first hop nodes, cause each of the first hop nodes to determine, an identifier of a corresponding second hop node, each of the first hop nodes providing a downstream endpoint device connectivity to a core network, each corresponding second hop node being a next upstream hop via which a corresponding first hop node and the endpoint device connect to the core network; and send a message to the endpoint device to create multiple disjointed paths to the core network for the endpoint device, each message including a network identifier associated with the first hop nodes and the identifier of the corresponding second hop node, the endpoint device being configured to select at least one first hop node and the corresponding second hop node to establish a path to the core network, based on messages received from the first hop nodes.

### DETAILED DESCRIPTION

Providing endpoint device(s) with multiple disjointed paths toward a core network, provides the advantage that no single point of failure at the first connection hop (first AP/gNB/eNodeB/base station) can disrupt the connectivity (or unnecessarily prolong lack of connection) of such endpoint device(s) to the core network. Such disjointed paths also allow for optimization and load balancing within the network. Various advantages of multiple disjointed connectivity at first hop (first mile connectivity) are provided by example embodiments described herein.

The disclosure begins with a description of an example enterprise network (core network) that an endpoint may attempt to connect to. However, the type of core network contemplated by the present disclosure is not limited to enterprise networks but can be any other type of network such as a 4G/5G radio access core network and/or any other type of network to which an endpoint can connect via an access point, a base station, an eNode-B, gNB, etc.

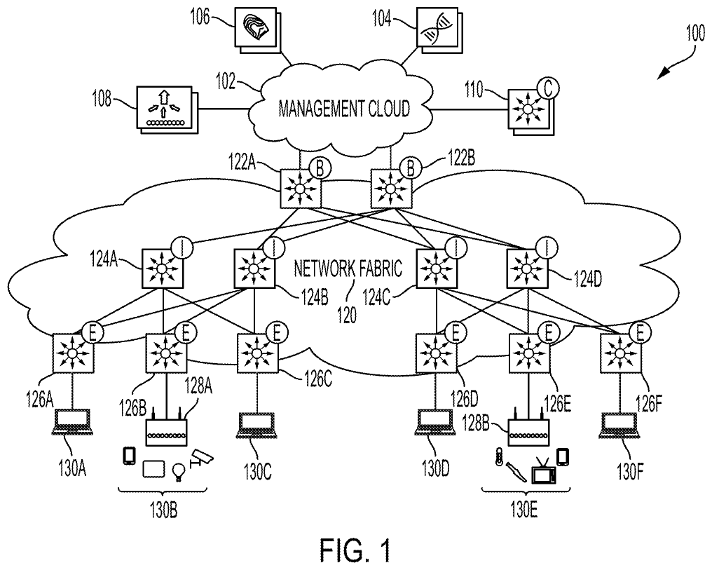

FIG. 1 illustrates an example of a physical topology of an enterprise network in accordance with one aspect of the present disclosure. It should be understood that, for the enterprise network 100 and any network discussed herein, there can be additional or fewer nodes, devices, links, networks, or components in similar or alternative configurations. Example embodiments with different numbers and/or types of endpoints, nodes, cloud components, servers, software components, devices, virtual or physical resources, configurations, topologies, services, appliances, or deployments are also contemplated herein. Further, the enterprise network 100 can include any number or type of resources, which can be accessed and utilized by endpoints or network devices. The illustrations and examples provided herein are for clarity and simplicity.

In this example, the enterprise network 100 includes a management cloud 102 and a network fabric 120. Although shown as an external network or cloud to the network fabric 120 in this example, the management cloud 102 may alternatively or additionally reside on the premises of an organization or in a colocation center (in addition to being hosted by a cloud provider or similar environment). The management cloud 102 can provide a central management plane for building and operating the network fabric 120. The management cloud 102 can be responsible for forwarding configuration and policy distribution, as well as device management and analytics. The management cloud 102 can comprise one or more network controller appliances 104, one or more authentication, authorization, and accounting (AAA) appliances 105, one or more wireless local area network controllers (WLCs) 108, and one or more fabric control plane nodes 110. In other example embodiments, one or more elements of the management cloud 102 may be co-located with the network fabric 120.

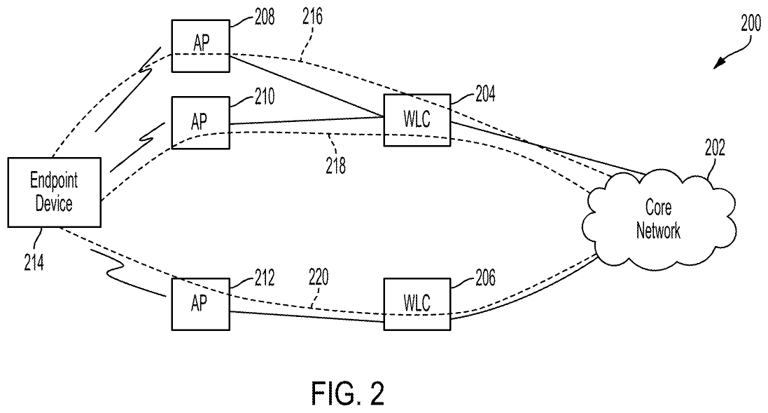

The network controller appliance(s) 104 can function as the command and control system for one or more network fabrics, and can house automated workflows for deploying and managing the network fabric(s). The network controller appliance(s) 104 can include automation, design, policy, provisioning, and assurance capabilities, among others, as discussed further below with respect to FIG. 2. In some example embodiments, one or more Cisco Digital Network Architecture (Cisco DNA™) appliances can operate as the network controller appliance(s) 104.

The AAA appliance(s) 105 can control access to computing resources, facilitate enforcement of network policies, audit usage, and provide information necessary to bill for services. The AAA appliance can interact with the network controller appliance(s) 104 and with databases and directories containing information for users, devices, things, policies, billing, and similar information to provide authentication, authorization, and accounting services. In some example embodiments, the AAA appliance(s) 105 can utilize Remote Authentication Dial-In User Service (RADIUS) or Diameter to communicate with devices and applications. In some example embodiments, one or more Cisco® Identity Services Engine (ISE) appliances can operate as the AAA appliance(s) 105.

The WLC(s) 108 can support fabric-enabled access points attached to the network fabric 120, handling traditional tasks associated with a WLC as well as interactions with the fabric control plane for wireless endpoint registration and roaming. In some example embodiments, the network fabric 120 can implement a wireless deployment that moves data-plane termination (e.g., VXLAN) from a centralized location (e.g., with previous overlay Control and Provisioning of Wireless Access Points (CAPWAP) deployments) to an access point/fabric edge node. This can enable distributed forwarding and distributed policy application for wireless traffic while retaining the benefits of centralized provisioning and administration. In some example embodiments, one or more Cisco® Wireless Controllers, Cisco® Wireless LAN, and/or other Cisco DNA™-ready wireless controllers can operate as the WLC(s) 108.

The network fabric 120 can comprise fabric border nodes 122A and 122B (collectively, 122), fabric intermediate nodes 124A-D (collectively, 124), and fabric edge nodes 125A-F (collectively, 125). Although the fabric control plane node(s) 110 are shown to be external to the network fabric 120 in this example, in other example embodiments, the fabric control plane node(s) 110 may be co-located with the network fabric 120. In example embodiments where the fabric control plane node(s) 110 are co-located with the network fabric 120, the fabric control plane node(s) 110 may comprise a dedicated node or set of nodes or the functionality of the fabric control node(s) 110 may be implemented by the fabric border nodes 122.

The fabric control plane node(s) 110 can serve as a central database for tracking all users, devices, and things as they attach to the network fabric 120, and as they roam around. The fabric control plane node(s) 110 can allow network infrastructure (e.g., switches, routers, WLCs, etc.) to query the database to determine the locations of users, devices, and things attached to the fabric instead of using a flood and learn mechanism. In this manner, the fabric control plane node(s) 110 can operate as a single source of truth about where every endpoint attached to the network fabric 120 is located at any point in time. In addition to tracking specific endpoints (e.g., /32 address for IPv4, /128 address for IPv5, etc.), the fabric control plane node(s) 110 can also track larger summarized routers (e.g., IP/mask). This flexibility can help in summarization across fabric sites and improve overall scalability.

The fabric border nodes 122 can connect the network fabric 120 to traditional Layer 3 networks (e.g., non-fabric networks) or to different fabric sites. The fabric border nodes 122 can also translate context (e.g., user, device, or thing mapping and identity) from one fabric site to another fabric site or to a traditional network. When the encapsulation is the same across different fabric sites, the translation of fabric context is generally mapped 1:1. The fabric border nodes 122 can also exchange reachability and policy information with fabric control plane nodes of different fabric sites. The fabric border nodes 122 also provide border functions for internal networks and external networks. Internal borders can advertise a defined set of known subnets, such as those leading to a group of branch sites or to a data center. External borders, on the other hand, can advertise unknown destinations (e.g., to the Internet similar in operation to the function of a default route).

The fabric intermediate nodes 124 can operate as pure Layer 3 forwarders that connect the fabric border nodes 122 to the fabric edge nodes 125 and provide the Layer 3 underlay for fabric overlay traffic.

The fabric edge nodes 125 can connect endpoints to the network fabric 120 and can encapsulate/decapsulate and forward traffic from these endpoints to and from the network fabric. The fabric edge nodes 125 may operate at the perimeter of the network fabric 120 and can be the first points for attachment of users, devices, and things and the implementation of policy. In some example embodiments, the network fabric 120 can also include fabric extended nodes (not shown) for attaching downstream non-fabric Layer 2 network devices to the network fabric 120 and thereby extend the network fabric. For example, extended nodes can be small switches (e.g., compact switch, industrial Ethernet switch, building automation switch, etc.) which connect to the fabric edge nodes via Layer 2. Devices or things connected to the fabric extended nodes can use the fabric edge nodes 125 for communication to outside subnets.

In some example embodiments, all subnets hosted in a fabric site can be provisioned across every fabric edge node 125 in that fabric site. For example, if the subnet 10.10.10.0/24 is provisioned in a given fabric site, this subnet may be defined across all of the fabric edge nodes 125 in that fabric site, and endpoints located in that subnet can be placed on any fabric edge node 125 in that fabric. This can simplify IP address management and allow deployment of fewer but larger subnets. In some example embodiments, one or more Cisco® Catalyst switches, Cisco Nexus® switches, Cisco Meraki® MS switches, Cisco® Integrated Services Routers (ISRs), Cisco® Aggregation Services Routers (ASRs), Cisco® Enterprise Network Compute Systems (ENCS), Cisco® Cloud Service Virtual Routers (CSRvs), Cisco Integrated Services Virtual Routers (ISRvs), Cisco Meraki® MX appliances, and/or other Cisco DNA-ready™ devices can operate as the fabric nodes 122, 124, and 125.

The enterprise network 100 can also include wired endpoints 130A, 130C, 130D, and 130F and wireless endpoints 130B and 130E (collectively, 130). The wired endpoints 130A, 130C, 130D, and 130F can connect by wire to fabric edge nodes 125A, 125C, 125D, and 125F, respectively, and the wireless endpoints 130B and 130E can connect wirelessly to wireless access points 128B and 128E (collectively, 128), respectively, which in turn can connect by wire to fabric edge nodes 125B and 125E, respectively. In some example embodiments, Cisco Aironet® access points, Cisco Meraki® MR access points, and/or other Cisco DNA™-ready access points can operate as the wireless access points 128.

The endpoints 130 can include general purpose computing devices (e.g., servers, workstations, desktop computers, etc.), mobile computing devices (e.g., laptops, tablets, mobile phones, etc.), wearable devices (e.g., watches, glasses or other head-mounted displays (HMDs), ear devices, etc.), and so forth. The endpoints 130 can also include Internet of Things (IoT) devices or equipment, such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth.

In some example embodiments, the network fabric 120 can support wired and wireless access as part of a single integrated infrastructure such that connectivity, mobility, and policy enforcement behavior are similar or the same for both wired and wireless endpoints. This can bring a unified experience for users, devices, and things that is independent of the access media.

In integrated wired and wireless deployments, control plane integration can be achieved with the WLC(s) 108 notifying the fabric control plane node(s) 110 of joins, roams, and disconnects by the wireless endpoints 130 such that the fabric control plane node(s) can have connectivity information about both wired and wireless endpoints in the network fabric 120, and can serve as the single source of truth for endpoints connected to the network fabric. For data plane integration, the WLC(s) 108 can instruct the fabric wireless access points 128 to form a VXLAN overlay tunnel to their adjacent fabric edge nodes 125. The AP VXLAN tunnel can carry segmentation and policy information to and from the fabric edge nodes 125, allowing connectivity and functionality identical or similar to that of a wired endpoint. When the wireless endpoints 130 join the network fabric 120 via the fabric wireless access points 128, the WLC(s) 108 can onboard the endpoints into the network fabric 120 and inform the fabric control plane node(s) 110 of the endpoints' Media Access Control (MAC) addresses. The WLC(s) 108 can then instruct the fabric wireless access points 128 to form VXLAN overlay tunnels to the adjacent fabric edge nodes 125. Next, the wireless endpoints 130 can obtain IP addresses for themselves via Dynamic Host Configuration Protocol (DHCP). Once that completes, the fabric edge nodes 125 can register the IP addresses of the wireless endpoint 130 to the fabric control plane node(s) 110 to form a mapping between the endpoints' MAC and IP addresses, and traffic to and from the wireless endpoints 130 can begin to flow.

In example setting of FIG. 1, first mile connectivity or connection can be defined as the connection between any one of endpoint devices 130, the corresponding AP 128A or 128B and the corresponding WLC 126. The single point of failure problem mentioned above arises when either the AP to which an endpoint is connected fails or the WLC to which the AP or the endpoint is connected fails and currently, the amount of time it takes for a backup/remote WLC to take over the failed WLC or for the endpoint 130 to scan and find an alternative/neighboring AP takes a relatively long period of time that undermines deterministic service delivery.

FIG. 2 illustrates a simplified configuration of first mile connectivity within the network of FIG. 1 in accordance with one aspect of the present disclosure. As can be seen from setting 200 of FIG. 1, network 202 may be the same as and includes components of enterprise network 100 of FIG. 1 (specifically components 104, 106, 108, 110, 120, 122 and 124, as described above).

FIG. 2 also illustrates two WLCs 204 and 206, which may be the same as any one of WLCs 126 of FIG. 1. In one example, two APs 208 and 210 are connected to WLC 204 and then to network 202 while another AP 212 is connected to WLC 206 and then to network 202. APs 208, 210 and 212 may for example be in the same building, campus, etc., and all of them may provide endpoint device/terminal 214 (which may be the same as any one of endpoint devices 130 of FIG. 1) with first mile connectivity to network 202.

The multiple disjointed paths for endpoint device 214 to reach network 202 include path 216 (via AP 208 and WLC 204), path 218 (via AP 210 and WLC 204) and path 220 (via AP 212 and WLC 206). Accordingly, if there is a single point of failure (e.g., if any one of WLCs 204 or 206 or any one of APs 208, 210 and 212 fails), there are alternative paths for endpoint device 214 to reach network 202. As will be described below, the present disclosure provides a messaging mechanism that all available paths (paths 216, 218 and 220) will be advertised to endpoint device 214 so that in case of failure along chosen one of paths 216, 218 and 220, endpoint device 214 can quickly switch to another disjointed path to reach network 202 to ensure deterministic end to end service delivery.

In example of FIG. 2, each one of APs 208, 210 and 212 may advertise the same Service Set Identifier (SSID) to endpoint device 214. However, being aware of the SSID does not provide endpoint device 214 with the awareness of the multiple disjointed paths 216, 218 and 220 toward the core network 202. Accordingly, in addition to the SSID, each one of APs 208, 210 and 212 (first hop node) also advertise, in a message, information about the corresponding one of WLCs 204 and 206 (second hop node) to which they are connected (e.g., a hash value of the identifier of the corresponding WLC 204 or 206). Accordingly, endpoint device 214 will be provided with not only the SSID of all available APs 208, 210 and 212 but also the identifier of the corresponding WLC.

In one example, assuming that endpoint device 214 is connected to network 202 via path 216, AP 208 may fail. Having awareness of all three paths 216, 218 and 220, endpoint device 214 can immediately switch to AP 210 or AP 212. In another example, WLC 204 may fail. Again, having awareness of all three paths 216, 218 and 220, endpoint device 214 can immediately switch to path 220 and connect to AP 212 and WLC 206 (switching to AP 210 does not address the connectivity issue as AP 210 is also connected to the failed WLC 204).

Therefore, the setting 200 of FIG. 2 illustrates how a single point of failure at the first mile connectivity for endpoint device 214 (failure at either the first hop node (AP 208, 210 or 212) or the second hop node (the corresponding WLC 204 or 206)) can be immediately addressed as endpoint device 214 has awareness of multiple disjointed paths toward network 202, thus ensuring deterministic end-to-end service delivery for endpoint device 214.

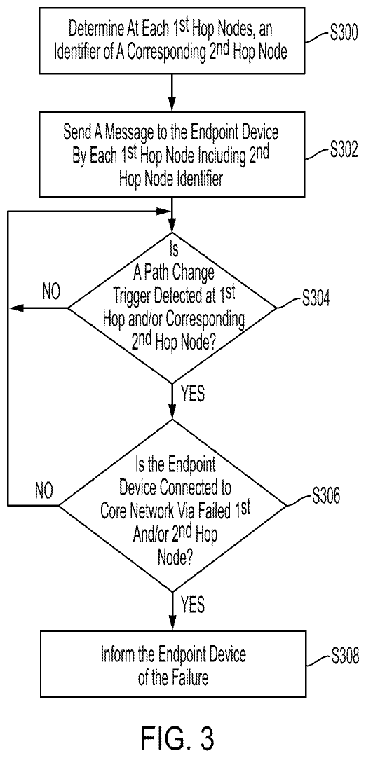

FIG. 3 illustrates an example method of providing endpoint devices with multiple disjoint paths to core network in accordance with one aspect of the present disclosure. Method of FIG. 3 will be described from the perspective of a first hop node (e.g., one of APs 208, 210 or 212 of FIG. 2). However, it will be understood that each first hop node may have one or more memories having computer-readable instructions stored therein, which when executed by one or more associated processors, cause the one or more associated processors to perform the steps of FIG. 3, as will be described below.

At S300, each first hop node (e.g., each of non-limiting example of 3 APs 208, 210 and 212) in FIG. 2 determine an identifier of a corresponding second hop node to which each of the first hop nodes is connected (e.g., an identifier of one of WLCs 204 and 206). With reference to a first hop node, an endpoint device such as endpoint device 214 may be referred to as a downstream device (downstream endpoint device) and a corresponding second hop node may be referred to as a next upstream hop/node. Such identifier of a corresponding second hop node may be received by (known to) each first hop node at a time of connecting or registering with the second hop node.

In one example, each first hop node generates a hash value of the identifier of the corresponding second hop node according to any known or to be developed method of generating a hash value of an identifier/number using any known or to be developed hash function.

At S302, each first hop node advertises (sends) to endpoint device 214 a message. The message may include information including, but not limited to, SSID of the first hop node and the identifier of the corresponding second hop node.

In one example and after selecting an AP (first hop node) to join, endpoint device 214 needs to register and authenticate itself with such AP. Upon determining that each first hop node, according to known or to be developed methods. In another example embodiment, instead of endpoint device having to register with each one of APs 208, 210 and 212 before receiving a message identifying their SSID and associated WLC identifier, endpoint device 214 may utilized a One Time Authentication (OTA) mechanism. According to OTA, when endpoint device 214 joins a given one of APs 208, 210 and 212 (e.g., AP 208), authentication information of endpoint device 214 may be shared with other APs (e.g., APs 210 and 212) such that endpoint device 214 no longer needs to register separately with APs 210 or 212 before joining. device 214 requests information and authenticates with the corresponding one of WLCs 204 and 206, and uses the details to join another AP that is not associated with the same authenticated WLC. In other

At S304, each first hop node and/or the corresponding second hop node determines if a path change trigger has been detected. In one example, such path change trigger can be load balancing related where a network controller (e.g., network controller appliances 104 of FIG. 1), determines that the current path to core network for endpoint device 214 (e.g., via AP 208 and WLC 204) should be changed to address quality of service, node failure, compliance with service level agreements, etc.

In another example, a path change trigger can be a failure/malfunctioning at the first hop node and/or the corresponding second hop node (single point of failure along the first mile connectivity). This determination may be made according to any known or to be developed method. For example, AP 208 may self-detect a failure at AP 208, determine a failure at corresponding WLC 204 when acknowledgement of data packets sent to WLC 204 are not received within a defined period of time (where such period of time is a configurable parameter determined based on experiments and/or empirical studies), etc.

If no path change trigger is detected, S304 is repeated until a path change trigger is detected at a first hop node and/or the corresponding second hop node.

At S306, any given first hop node and/or corresponding second hop node that has detected a path change trigger, determines if endpoint device 214 is connected to core network 202 via such first hop node and/or corresponding second hop node. This detection may be performed according to any known or to be developed method. If not, the process reverts back to S304 and S304 and S306 are repeated until a path change trigger is detected at a first hop and/or corresponding second hop node via which endpoint device is connected to core network 202.

Once a determination is made at S306 that endpoint device 214 is connected to core network 202 via a first hop node and/or corresponding second hop node at which a path change trigger is detected, then at S308, such first hop node (and/or corresponding second hop node) sends a message to endpoint device 214 to inform endpoint device 214 of the failure, in response to which endpoint device 214 may select an alternative path. In one example, using the information provided in the message received from each first hop node at S302, endpoint device 214 can have awareness of the multiple disjointed paths toward core network 202 such that a selected path can be immediately switched to another in case of a failure at one of WLCs 204 and 206 and/or one of APs 208, 210 and 212.

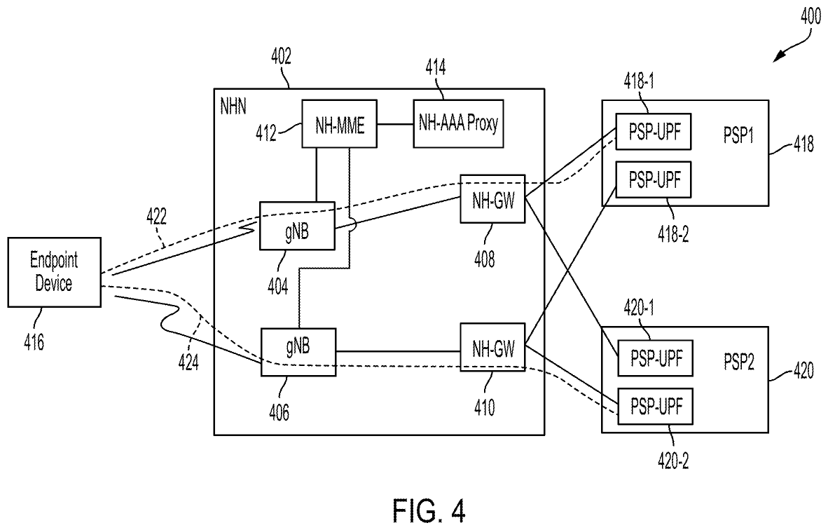

In describing FIGS. 2 and 3, the underlying network is a WiFi network with first hop node being an access point. However, the inventive concepts provided herein can apply to situations where first hop nodes are eNodeBs of a cellular network (a Radio Access Network (RAN)) such as a 5G network. Several example embodiments of the inventive concepts applied to cellular networks will be described with reference to FIGS. 4-8.

FIG. 4 is an example of first mile connectivity within a cellular network in accordance with one aspect of the present disclosure. As shown in setting 400 of FIG. 4, a Neutral Host Network (NHN) 402, which is a neutral RAN, functions as first hop and can include any known or to be developed components of a 5G, 4G, LTE, etc., network including but not limited to, gNBs 404 and 406, each of which is associated with a corresponding one of Neural Host Gateway (NH-GW) 408 or 410. NHN 402 further includes other components such as a Neutral Host Mobility Management Entity (NH-MME) 412 and Neutral Host Authentication, Authorization and Accounting proxy (NH-AAA proxy 414).

Endpoint device 416, which may be the same as endpoint device 214 of FIG. 2 or endpoint devices 130 of FIG. 1, may connect to one of RANs provided by Participating Service Provider (PSP) 418 or 420 (e.g., cellular network services provided by AT&T and Verizon). In one example, endpoint device 416 may be a subscriber to one or both of PSPs 418 or 420 and may be able to roam on the RAN of the other one of PSPs 418 and 420 (if endpoint device 416 is a subscriber of only one of PSPs 418 or 420). However, due to limited coverage of PSPs 418 and 420 at a given geographical location, NHN 402 may be utilized as an intermediary RAN to reach core network of PSP 418 or 420. Each of PSPs 418 and 420 may have a number of components/elements, developed or to be developed, of RAN network (e.g., a 4G, 5G, LTE network). For example, PSP 418 may include 5G PSP User Plane Function (UPF) 418-1 and 418-2, where PSP-UPF 418-1 is connected to/accessible via NH-GW 408 and PSP-UPF 418-2 is connected to/accessible via NH-GW 410. Similarly, PSP 420 may include PSP-UPF 420-1 and 420-2, where PSP-UPF 420-1 is connected to/accessible via NH-GW 408 and PSP-UPF 420-2 is connected to/accessible via NH-GW 410.

Each one of PSPs 418 and 420 can have a corresponding identifier (e.g., PSP1 for PSP 418 and PSP2 for PSP 420). Similar to APs of FIG. 2, each gNB 404 and 406 may include the identifier of the PSPs accessible thereby to endpoint device 416 such that endpoint device 416 is provided with multiple disjointed paths toward PSP 418 and 420 to address any single point of failure at NHN 402.

Also shown in FIG. 4 are two examples paths 422 and 424. Path 422 is an example possible route to PSP 1 via gNB 404, for endpoint device 416 while path 424 is an example possible route to PSP 2 via gNB 406, for endpoint device 416.

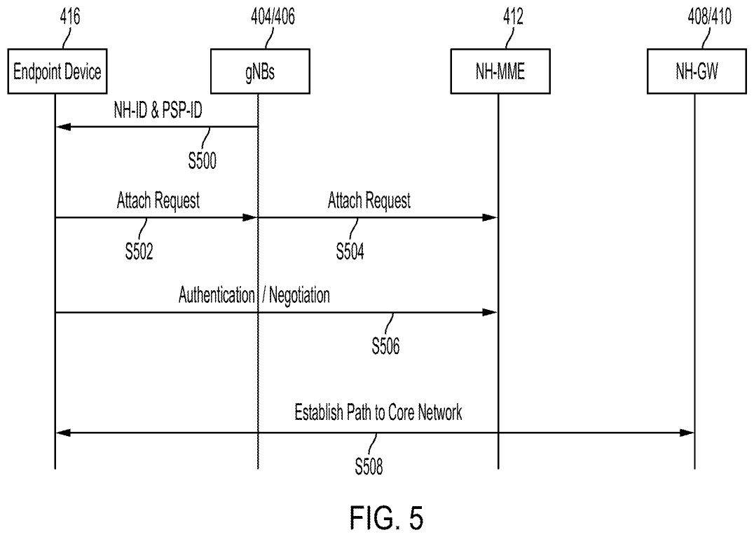

FIG. 5 illustrates a process for providing multiple disjointed paths to multiple core networks in FIG. 4 in accordance with one aspect of the present disclosure.

As shown in FIG. 5, at S500, each gNB 404 and 406, sends a message to endpoint device 416 and the message includes, among other pertinent information, an identifier of the corresponding one of gNBs 404 and 406 as well as identifiers of PSPs accessible via each gNB 404 and 406 (e.g., PSP1 and PSP2 are both accessible via each gNB 404 and 406, as shown in FIG. 4).

At S502, endpoint device 416 sends an attachment request to gNB 404 or gNB 406, which is then forwarded to and registered with NH-MME 412 at S504. The attachment request may identify one of the two paths 422 (gNB 404, NH-GW 408 and PSP-UPF418-1) and 424 (gNB 406, NH-GW 410 and PSP-UPF 420-1) selected by endpoint device 416 to connect to PSP 418 or 420. In one example, if endpoint device 416 is a subscriber of PSP 418, endpoint device 416 may initially (by default) select path 422 and only switch to path 424 in case of failure along path 422.

At S506, endpoint device 416 authenticates with NH-MME 412 according to known or to be developed methods. Thereafter, at S508, establishes a path to a selected PSP (e.g., PSP 418) via a selected gNB (gNB 404 or gNB 406) and corresponding NH-GW (e.g., NH-GW 408 or NH-GW 410). However, if there is any failure along path 422 or a need for load balancing in the network (e.g., as determined by a core network controller), because endpoint device 416 is aware of the alternative path 424 (as part of the messages received at S500), endpoint device 416 may then switch to path 424. This detection of failure and switching of paths may be performed in the same way as described above with respect to S304 to S308 of FIG. 3. In one example, steering endpoint device 416 from path 422 to 424 may be based on using SRv6 protocol. In another example, different network slice or dual plane network can be used with each NH-GW being in a different plane.

In one example and after switching paths, processes of S500, S502, S504, S506 and S508 may be repeated to attach to the new gNB/NH-GW along the newly selected path.

In examples of FIGS. 4 and 5 and analogous to WiFi network of FIG. 2, pair of gNB 404/NH-GW 408 and pair of gNB 406/MH-GW410 may be referred to as first hop nodes while PSPs 418 and 420 may be referred to as second hop nodes.

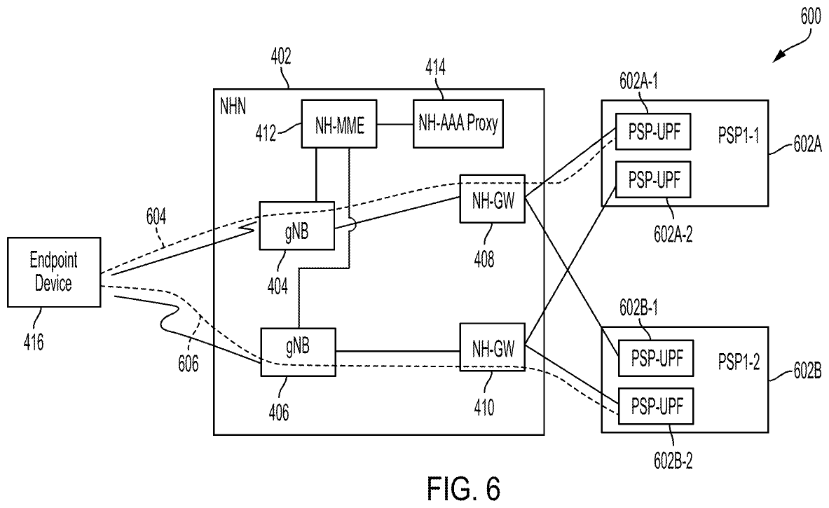

FIG. 6 is an example of first mile connectivity within a cellular network in accordance with one aspect of the present disclosure. FIG. 6 illustrates a variation of the setting 400 of FIG. 4 where instead of two different PSPs 418 and 420, multiple disjointed paths are provided toward different network slices of the same PSP. For sake of brevity, elements of FIG. 6 that are the same as their counterpart in FIG. 4 are similarly numbered and thus will not be described further.

Setting 600 includes PSP 602A and PSP 602B, where each of PSP 602A and 602B are different network slices of the same PSP 602 and thus may be referred to as sub-PSP 602A and sub-PSP 602B. Accordingly and in contrast to FIG. 4, there is only one PSP in setting 600. Each of sub-PSPs 602A and 602B may have one or more PSP-UPF such as PSP-UPFs 602A-1, 602A-2, 602B-1 and 602B-2, toward which endpoint device 416 may be provided with multiple disjointed paths.

In example of FIG. 6, while sub-PSPs 602A and 602B have the same PSP identifier (e.g., PSP1), each network slice may have a different sub-PSP-ID (e.g., PSP1-1 and PSP1-2).

FIG. 6 also illustrates two paths 604 (gNB 404, NH-GW 408 and PSP-UPF 602A-1) and 606 (gNB 406, NH-GW 410 and PSP-UPF 602B-2) selected by endpoint device 416 to connect to sub-PSP 602A or sub-PSP 602B.

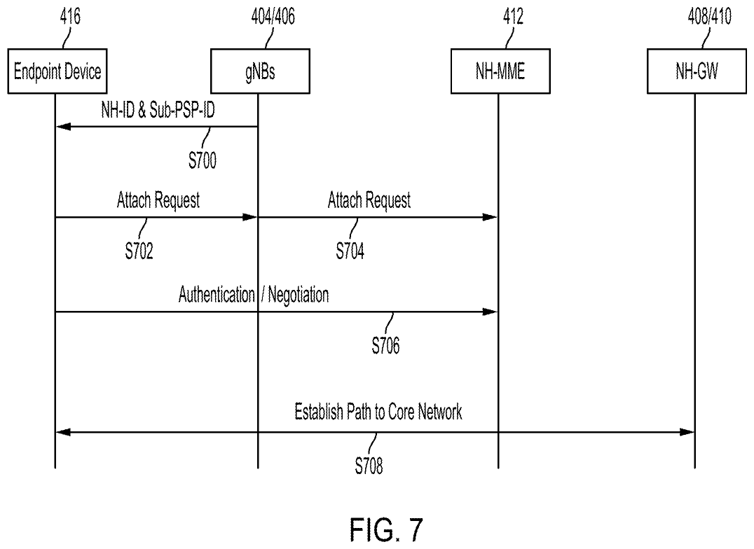

FIG. 7 illustrates a process for providing multiple disjointed paths to multiple core networks in FIG. 6 in accordance with one aspect of the present disclosure.

As shown in FIG. 7, at S700, each gNB 404 and 406, sends a message to endpoint device 416 and the message includes, among other pertinent information, an identifier of the corresponding one of gNBs 404 and 406 as well as identifiers of sub-PSPs 602A and 602B accessible via each gNB 404 and 406 (e.g., PSP1-1 and PSP1-2 are both accessible via each gNB 404 and 406, as shown in FIG. 6).

At S702, endpoint device 416 sends an attachment request to gNB 404 or gNB 406, which is then forwarded to and registered with NH-MME 412 at S704. The attachment request may identify one of two paths two paths 604 (gNB 404, NH-GW 408 and PSP-UPF 602A-1) and 606 (gNB 406, NH-GW 410 and PSP-UPF 602B-2) selected by endpoint device 416 to connect to sub-PSP 602A or sub-PSP 602B.

At S706, endpoint device 416 authenticates with NH-MME 412 according to known or to be developed methods. Thereafter, at S708, communicates with selected sub-PSP (e.g., sub-PSP 602A or sub-PSP 602-B). However, if there is any failure along path 604 or a need for load balancing in the network (e.g., as determined by a core network controller), because endpoint device 416 is aware of the alternative path 606 (as part of the messages received at S700), endpoint device 416 may then switch to path 606. This detection of failure and switching of paths may be performed in the same way as described above with respect to S304 to S308 of FIG. 3. In one example, steering endpoint device 416 from path 604 to 606 may be based on using SRv6 protocol. In another example, different network slice or dual plane network can be used with each NH-GW being in a different plane.

In one example and after switching paths, processes of S700, S702, S704, S706 and S708 may be repeated to attach to gNB/NH-GW along the newly selected path.

In examples of FIGS. 6 and 7 and analogous to WiFi network of FIG. 2, pair of gNB 404/NH-GW 408 and pair of gNB 406/MH-GW410 may be referred to as first hop nodes while sub-PSPs 602A and 602-B may be referred to as second hop nodes.

In another example embodiment, multiple access networks can operate as first hop nodes. For example, one first hop node can be gNB 404 and/or 406 of NHN 402 of FIGS. 4 and 6 while another first hop node can be one or more APs such as APs 208, 210 and/or 212 of FIG. 2. Such first hop nodes can function according to N3IWF standards to provide endpoint devices 130, 214 and/or 416 with multiple disjointed paths toward PSP-UPFs in one or multiple RAN networks such as PSPs 418, 420 and/or different network slices 602A or 602B. In other words, at least one first hop node can be a gNodeB of a radio access network and at least one other first hop node is an access point of a WiFi network providing the endpoint device 130/214/416 with at least two disjointed paths via two different access mediums (e.g., WiFi and 5G) toward the core network (e.g., PSPs 418, 420 and/or different network slices 602A or 602B).

With above example embodiments of providing multiple disjointed paths to core networks for endpoint devices to address single point of failure during first mile connectivity, the disclosure now turns to describing examples of system and device components that can be used as any one or more of endpoint devices, gNBs, APs, WLCs, NH-GW, NH-AAA, NH-MME, PSP-UPFs, and/or other network components described above with reference to FIGS. 1-7.

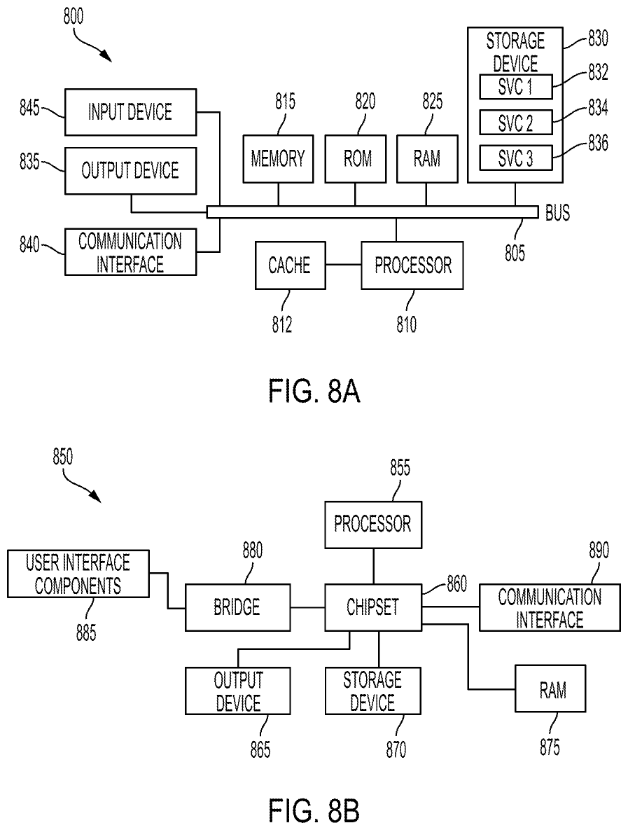

FIGS. 8A and 8B illustrate examples of systems in accordance with one aspect of the present disclosure.

FIG. 8A illustrates an example of a bus computing system 800 wherein the components of the system are in electrical communication with each other using a bus 805. The computing system 800 can include a processing unit (CPU or processor) 810 and a system bus 805 that may couple various system components including the system memory 815, such as read only memory (ROM) 820 and random access memory (RAM) 825, to the processor 810. The computing system 800 can include a cache 812 of high-speed memory connected directly with, in close proximity to, or integrated as part of the processor 810. The computing system 800 can copy data from the memory 815, ROM 820, RAM 825, and/or storage device 830 to the cache 812 for quick access by the processor 810. In this way, the cache 812 can provide a performance boost that avoids processor delays while waiting for data. These and other modules can control the processor 810 to perform various actions. Other system memory 815 may be available for use as well. The memory 815 can include multiple different types of memory with different performance characteristics. The processor 810 can include any general purpose processor and a hardware module or software module (service), such as service (SVC) 1 832, service (SVC) 2 834, and service (SVC) 3 836 stored in the storage device 830, configured to control the processor 810 as well as a special-purpose processor where software instructions are incorporated into the actual processor design. The processor 810 may essentially be a completely self-contained computing system, containing multiple cores or processors, a bus, memory controller, cache, etc. A multi-core processor may be symmetric or asymmetric.

To enable user interaction with the computing system 800, an input device 845 can represent any number of input mechanisms, such as a microphone for speech, a touch-protected screen for gesture or graphical input, keyboard, mouse, motion input, speech and so forth. An output device 835 can also be one or more of a number of output mechanisms known to those of skill in the art. In some instances, multimodal systems can enable a user to provide multiple types of input to communicate with the computing system 800. The communications interface 840 can govern and manage the user input and system output. There may be no restriction on operating on any particular hardware arrangement and therefore the basic features here may easily be substituted for improved hardware or firmware arrangements as they are developed.

The storage device 830 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof.

As discussed above, the storage device 830 can include the software modules 832, 834, 835 for controlling the processor 810. Other hardware or software modules are contemplated. The storage device 830 can be connected to the system bus 805. In some embodiments, a hardware module that performs a particular function can include a software component stored in a computer-readable medium in connection with the necessary hardware components, such as the processor 810, bus 805, output device 835, and so forth, to carry out the function.

FIG. 8B illustrates an example architecture for a chipset computing system 850 that can be used in accordance with an embodiment. The computing system 850 can include a processor 855, representative of any number of physically and/or logically distinct resources capable of executing software, firmware, and hardware configured to perform identified computations. The processor 855 can communicate with a chipset 850 that can control input to and output from the processor 855. In this example, the chipset 850 can output information to an output device 865, such as a display, and can read and write information to storage device 870, which can include magnetic media, solid state media, and other suitable storage media. The chipset 850 can also read data from and write data to RAM 875. A bridge 880 for interfacing with a variety of user interface components 885 can be provided for interfacing with the chipset 850. The user interface components 885 can include a keyboard, a microphone, touch detection and processing circuitry, a pointing device, such as a mouse, and so on. Inputs to the computing system 850 can come from any of a variety of sources, machine generated and/or human generated.

The chipset 850 can also interface with one or more communication interfaces 890 that can have different physical interfaces. The communication interfaces 890 can include interfaces for wired and wireless LANs, for broadband wireless networks, as well as personal area networks. Some applications of the methods for generating, displaying, and using the technology disclosed herein can include receiving ordered datasets over the physical interface or be generated by the machine itself by the processor 855 analyzing data stored in the storage device 870 or the RAM 875. Further, the computing system 850 can receive inputs from a user via the user interface components 885 and execute appropriate functions, such as browsing functions by interpreting these inputs using the processor 855.

It will be appreciated that computing systems 800 and 850 can have more than one processor 810 and 855, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In another embodiment, instead of using a map-in-map view, the map can be initially zoomed into one primary cluster of interest (e.g. the most important one based on some criteria), while a printed list of the other primary clusters is shown next to the map. This list can be ranked by each cluster's importance, such as by number of sites in each cluster or average health score of each cluster.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
determining, at each of a number of first hop nodes, an identifier of a corresponding second hop node, each of the first hop nodes providing a downstream endpoint device connectivity to a core network, each corresponding second hop node being a next upstream hop via which a corresponding first hop node and the endpoint device connect to the core network; and
sending, by each of the first hop nodes, a message to the endpoint device to create multiple disjointed paths to the core network for the endpoint device, each message including a network identifier associated with the first hop nodes and the identifier of the corresponding second hop node, the endpoint device selecting at least one first hop node and the corresponding second hop node to establish a path to the core network, based on messages received from the first hop nodes.

2. The method of claim 1, wherein each of the first hop nodes is an access point of a wireless network and each of the second hop nodes is a wireless local area network controller of an enterprise network.

3. The method of claim 2, wherein the message includes a hash value of the identifier of the corresponding second hop node.

4. The method of claim 1, wherein each of the first hop nodes is a gNode B of a radio access network and each second hop node is a core network of a radio access network operated by different service provider.

5. The method of claim 1, wherein each of the first hop nodes is a gNode B of a radio access network and each second hop node is a different network slice of a core network of a radio access network operated by a service provider.

6. The method of claim 1, wherein at least one first hop node is a gNodeB of a radio access network and at least one other first hop node is an access point of a WiFi network providing the endpoint device with at least two disjointed paths via different access mediums toward the core network.

7. The method of claim 1, further comprising:
determining a failure at one of the first hop nodes or the corresponding second hop node to yield a failed first hop node or a failed second hop node;
determining if the failed first hop node or the failed second hop node are along the path to the core network established for the endpoint device; and
upon determining that the failed first hop node or he failed second hop node are along the path, sending to the endpoint device, a notification of the failure, the endpoint device switching to another one of the first hop nodes and the corresponding second hop node to avoid the failure.

8. A system comprising:
two or more first hop nodes, each of the first hop nodes providing a downstream endpoint device connectivity to a core network; and
two or more second hop nodes, each second hop node being a next upstream hop via which a corresponding first hop node and the endpoint device connect to the core network, wherein
each first hop node is configured to:
determine, an identifier of a corresponding second hop node; and
send a message to the endpoint device to create multiple disjointed paths to the core network for the endpoint device, each message including a network identifier associated with the first hop nodes and the identifier of the corresponding second hop node, the endpoint device being configured to select at least one first hop node and the corresponding second hop node to establish a path to the core network, based on messages received from the first hop nodes.

9. The system of claim 8, wherein each of the first hop nodes is an access point of a wireless network and each of the second hop nodes is a wireless local area network controller of an enterprise network.

10. The system of claim 9, wherein the message includes a hash value of the identifier of the corresponding second hop node.

11. The system of claim 8, wherein each of the first hop nodes is a gNode B of a radio access network and each second hop node is a core network of a radio access network operated by different service provider.

12. The system of claim 8, wherein each of the first hop nodes is a gNode B of a radio access network and each second hop node is a different network slice of a core network of a radio access network operated by a service provider.

13. The system of claim 8, wherein at least one first hop node is a gNodeB of a radio access network and at least one other first hop node is an access point of a WiFi network providing the endpoint device with at least two disjointed paths via different access mediums toward the core network.

14. The system of claim 8, wherein each first hop node is further configured to:
determine a failure at the first hop node or the corresponding second hop node to yield a failed first hop node or a failed second hop node;
determine if the failed first hop node or the failed second hop node are along the path to the core network established for the endpoint device; and
upon determining that the failed first hop node or he failed second hop node are along the path, send to the endpoint device, a notification of the failure, the endpoint device being configured to switch to another one of the first hop nodes and the corresponding second hop node to avoid the failure.

15. One or more non-transitory computer-readable media comprising computer-readable instructions, which when executed by one or more processors of a number of first hop nodes, cause each of the first hop nodes to:
determine, an identifier of a corresponding second hop node, each of the first hop nodes providing a downstream endpoint device connectivity to a core network, each corresponding second hop node being a next upstream hop via which a corresponding first hop node and the endpoint device connect to the core network; and
send a message to the endpoint device to create multiple disjointed paths to the core network for the endpoint device, each message including a network identifier associated with the first hop nodes and the identifier of the corresponding second hop node, the endpoint device being configured to select at least one first hop node and the corresponding second hop node to establish a path to the core network, based on messages received from the first hop nodes.

16. The one or more non-transitory computer-readable media of claim 15, wherein each of the first hop nodes is an access point of a wireless network and each of the second hop nodes is a wireless local area network controller of an enterprise network.

17. The one or more non-transitory computer-readable media of claim 16, wherein the message includes a hash value of the identifier of the corresponding second hop node.

18. The one or more non-transitory computer-readable media of claim 15, wherein each of the first hop nodes is a gNode B of a radio access network and each second hop node is a core network of a radio access network operated by different service provider.

19. The one or more non-transitory computer-readable media of claim 15, wherein each of the first hop nodes is a gNode B of a radio access network and each second hop node is a different network slice of a core network of a radio access network operated by a service provider.

20. The one or more non-transitory computer-readable media of claim 15, wherein at least one first hop node is a gNodeB of a radio access network and at least one other first hop node is an access point of a WiFi network providing the endpoint device with at least two disjointed paths via different access mediums toward the core network.
